(19) United States
(12) Patent Application Publication
(10) Pub. No.: US 2013/0218461 A1
(43) Pub. Date: Aug. 22, 2013

(54) Reduced Drift Dead Reckoning System

(71) Applicant: Leonid Naimark, Boston, MA (US)

(72) Inventor: Leonid Naimark, Boston, MA (US)

(21) Appl. No.: 13/774,776

(22) Filed: Feb. 22, 2013

Related U.S. Application Data
(60) Provisional application No. 61/601,778, filed on Feb. 22, 2012.

(51) Int. Cl. G01C 21/12

(52) U.S. Cl. CPC G01C 21/12
USPC 701/505

(57) ABSTRACT

A system and a method are disclosed for a dead reckoning module. The dead reckoning module receives sensor information from an inertial sensor module indicating translation and rotation information. The dead reckoning module determines the position of the inertial sensor module between two periods of time by calculating a movement from the a first time period to an intermediate time period, and from the second time period to the intermediate time period, and determines the total movement between the first and second time periods using the movements relating to the intermediate period.

### CROSS REFERENCE TO RELATED APPLICATIONS

This application claims the benefit of U.S. Provisional Application No. 61/601,778, filed Feb. 22, 2012, which is incorporated by reference in its entirety.

### BACKGROUND

1. Field of Art

The disclosure generally relates to the field of navigation and dead reckoning, and more specifically to dead reckoning on a mobile device.

2. Description of the Related Art

Dead reckoning systems provide information about the movement and position of a system or device using inertial sensors. Inertial sensors in consumer products typically have a low sampling rate and can accumulate a likelihood of error, or “sensor drift” relatively quickly. That is, as the sensor measures information about its surroundings, the sensor naturally accumulates an error or drift from its starting position. For these sensors, traditional dead reckoning algorithms typically fail to produce adequate results and can have an error that increases to unsatisfactory levels too quickly. In particular, the traditional dead reckoning algorithm does not produce adequate results on many consumer products.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

Figure (FIG. 1 shows a system for displaying augmented reality (AR) content which incorporates a dead reckoning system according to one embodiment.

FIG. 2 shows the components of an AR system incorporating a dead reckoning system according to one embodiment.

FIG. 3 illustrates the components of a dead reckoning calculation according to one embodiment.

FIG. 4 illustrates one embodiment of components of an augmented reality system.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

A system, method and computer readable storage medium includes an improved dead reckoning system according to one embodiment. In one example embodiment, the dead reckoning system receives sensor information from an inertial unit, which may provide readings from several accelerometers and gyroscopes. The dead reckoning system determines the movement and position of the inertial unit (and thereby the entire system, provided the inertial unit is fixed to the system), by calculating two segments of movement for each period of time. A first positional change is measured between the first period of time and an intermediate period of time, and a second is measured between the second period of time and the intermediate period of time. These two segments are combined to provide the final translation between the first and second period of time.

### Augmented Reality Occlusion

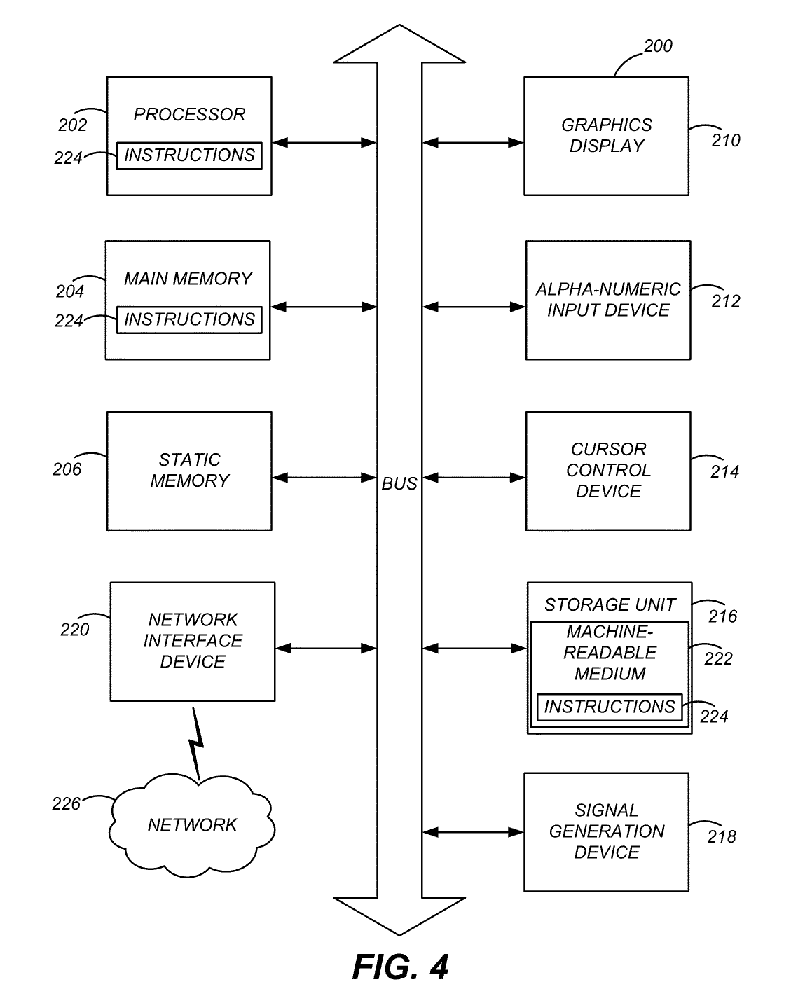

FIG. 1 shows an overview of a system for displaying augmented reality (AR) content according to one embodiment. The user uses a mobile device 102, which includes in one example embodiment a camera, inertial sensors and a screen in addition to additional components further described in FIG. 4. The mobile device 102 depicts real world objects 103 which can be viewed as real world objects 103 on a live video 104 on the screen. The real world objects 103 are translated into an internal three-dimensional representation. The mobile device uses the video captured by the camera as well as inertial sensors to determine the position (“pose”) of the mobile device 102 with respect to the real world objects 103 and within the internal three-dimensional (“3D”) representation. Using the pose of the mobile device 102, virtual content 101 is superimposed on the real world objects 103 on the screen of the mobile device 102. In one embodiment, the pose of the mobile device 102 is calculated using the video captured by the camera as well as the inertial sensors. Using the pose of the mobile device 102, the system overlays the virtual content 101 so that the virtual content 101 appears to be fixed with respect to the real world displayed on the screen. As the mobile device 102 is moved in space relative to real world objects 103, the location of the virtual content 101 is identified and maintained relative to the real world objects 103 displayed on the screen.

In particular, calculating the position of the mobile device 102 is used for rendering of the virtual content 101 to ensure the user obtains the correct perspective of the virtual content 101. For example, the calculated position my look to x, y, and z positions based on inertial sensors and a camera to determine the mobile device's 102 position relative to real world objects.

### Augmented Reality System Components

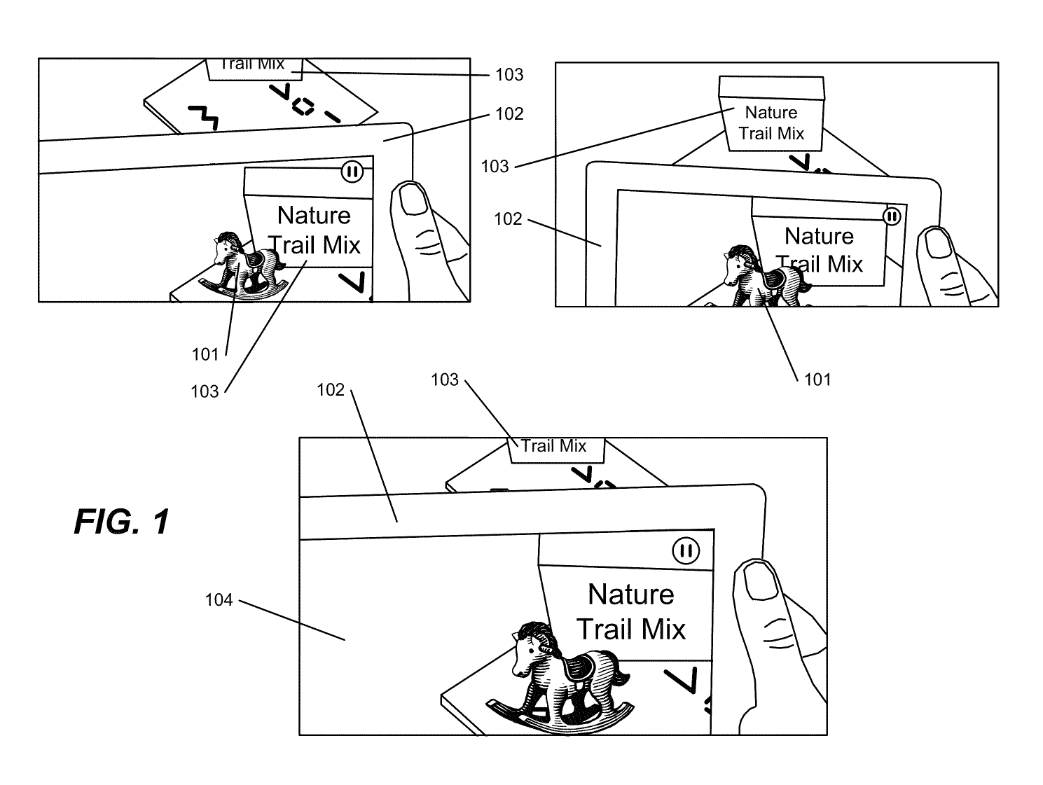

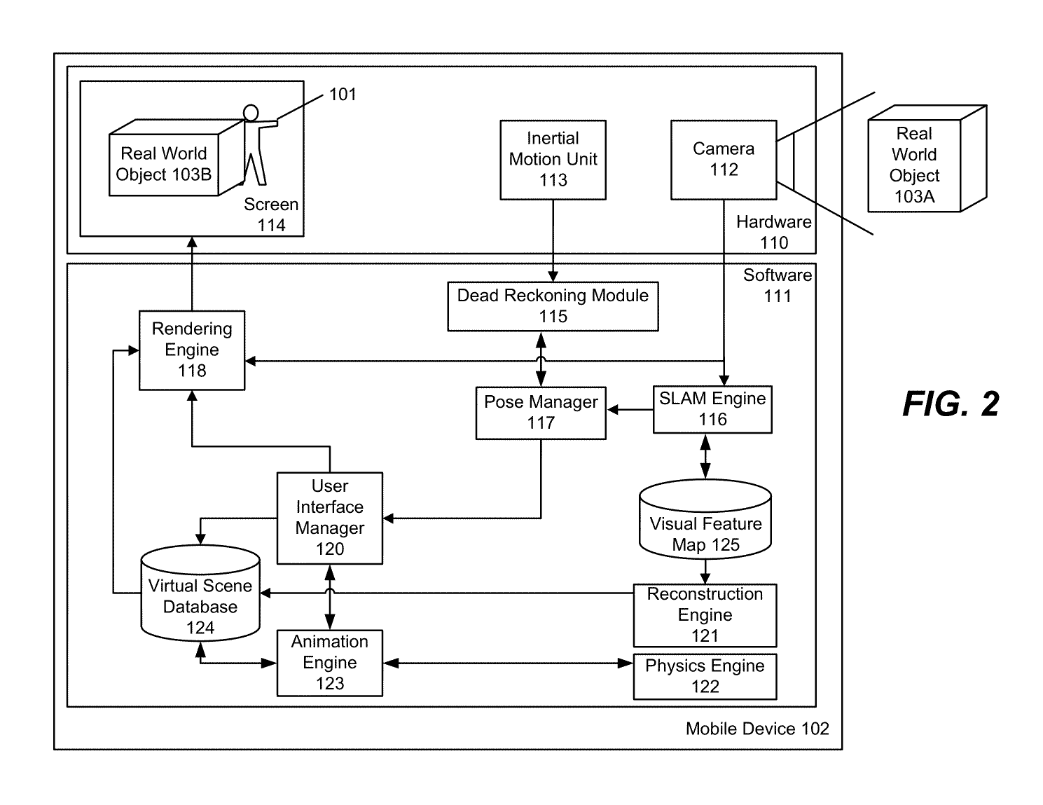

Referring now to FIG. 2, the components of an AR system are shown according to one embodiment. As shown in this embodiment, the mobile device includes several hardware components 110 and software components 111. In varying embodiments, the software components 111 may be implemented in specialized hardware rather than implemented in general software or on one or more processors.

The hardware components 110 in one embodiment can be those such as the mobile device 102. For example, the hardware components 110 in one embodiment include a camera 112, an inertial motion unit 113, and a screen 114. The camera 112 captures a video feed of real objects 103. The video feed is provided to other components of the system to enable the system to determine the pose of the system relative to real objects 103, construct a three-dimensional representation of the real objects 103, and provide the augmented reality view to the user.

The inertial motion unit (IMU) 113 is a sensing system composed of several inertial sensors which includes an accelerometer, gyroscope, and magnetometers. In other embodiments, additional sensing systems are used which also provide information about movement of the mobile device 102 in space. The IMU 113 provides inertial motion parameters to the software 111. The IMU 113 is rigidly attached to the mobile device 102 and thereby provides an indication of the movement of the entire system and is used to determine the pose of the system relative to the real world objects 103A viewed by the camera 112. The inertial parameters provided by the IMU 113 include linear acceleration, angular velocity and gyroscopic orientation with respect to the ground. In one embodiment the sensors include at least 3 accelerometers and 3 gyroscopes mounted orthogonally. As such, the sensors provide six degrees of freedom—3 translation-related values and 3 rotation-related values. In alternate embodiments, fewer or more accelerometers or gyroscopes are used. When fewer than three accelerometers or gyroscopes are used, a parameter for a degree of freedom that is not directly represented by a sensor may be calculated based on the other sensors, or may be calculated by other means. The raw sensor data is used to calculate motion from one reading to another.

The screen 114 displays a live video feed 104 to the user and can also provide an interface for the user to interact with the mobile device 102. The screen 114 displays the real world object 103B and rendered virtual content 101. As shown here, the rendered virtual content 101 may be at least partially occluded by the real world object 103B on the screen 114.

The software components 111 provide various modules and functionalities for enabling the system to place virtual content with real content on the screen 114. The general functions provided by the software components 111 in this embodiment are to identify a three-dimensional representation of the real world objects 103A, to determine the pose of the mobile device 102 relative to the real world objects 103A, to render the virtual content using the pose of the mobile device with respect to the real world objects, and to enable user interaction with the virtual content and other system features. The components used in one embodiment to provide this functionality are further described below.

The software 111 includes a dead reckoning module (DRM) 115 to compute the pose of the mobile device 102 using the inertial data. That is, the DRM uses the data from the IMU 113 to compute the inertial pose, that is the position and orientation of the mobile device 102 with respect to the real world objects 103. The DRM 115 uses dead-reckoning algorithms to iteratively compute the pose relative to the last computed pose using the measurements from the IMU 113. In one embodiment, the DRM calculates the relative change in pose of the mobile device 102 and further provides a scale for the change in pose, such as a length or distance parameter measured in inches or millimeters.

Typical dead reckoning algorithms can produce unacceptably large drift in the measurement used by the dead reckoning module. For example, the standard dead reckoning method used for a mobile phone does not guarantee more than 0.5 seconds of motion before the dead reckoning position error grows to over 0.02 meters. The dead reckoning method described in further detail below provides improved dead reckoning measurements.

Continuing, a Simultaneous Localization and Mapping (SLAM) engine receives the video feed from the camera 112 and creates a three-dimensional (3D) spatial model of visual features in the video frames. Visual features are generally specific locations of the scene that can be easily recognized from the reset of the scene and followed in subsequent video frames. For example, the SLAM engine 116 can identify edges, flat surfaces, corners, and other features of real objects. The actual features used can change according to the implementation, and may vary for each scene depending on which type of features provide the best object recognition. The features chosen can also be determined by the ability of the system to follow the particular feature frame-by-frame. By following those features in several video frames and thereby observing those features from several perspectives, the SLAM engine 116 is able to determine the 3D location of each feature through stereoscopy and in turn create a visual feature map 125.

In addition, the SLAM engine 116 further correlates the view of the real world captured by the camera 112 with the visual feature map 125 to determine the pose of the camera 112 with respect to the scene 103. This pose is also the pose of the hardware assembly 110 or the device 102 since the camera is rigidly attached and part of those integrated components.

The pose manager 117 manages the internal representation of the pose of the mobile device 102 relative to the real world. The pose manager 117 obtains the pose information provided by the dead reckoning module 115 and the SLAM engine 116 and fuses the information into a single pose. Generally, the pose provided by the IMU 113 is most reliable when the mobile device 102 is in motion, while the pose provided by the SLAM engine 116 (which was captured by the camera 112) is most reliable while the mobile device 102 is stationary. By fusing the information from the both poses, the pose manager 117 generates a pose which is more robust than either alone and can reduce the statistical error associated with each.

The pose estimation function determines the pose of the hardware assembly 110 or system 102. The pose manager 117 computes this pose by fusing the inertial-based pose computed by the dead-reckoning module 115 and the vision based pose computed by the SLAM engine 116 using a fusion algorithm and makes that pose available for other software components. The fusion algorithm can be, for example, a Kalman filter. The SLAM engine 116 produces the vision-based pose using a SLAM algorithm, using camera video frames from different perspectives of the scene 103 to create a visual map 125. It then correlates the live video from the camera 112 with this visual feature map 125 to determine the pose of the camera with respect to the scene 103. The DRM 115 produces the inertial-based pose using the raw inertial data coming from the IMU 113.

The visual feature map 125 is a data structure which encodes the 3D location and other parameters describing the visual features generated by the SLAM engine 116 as the scene 103A is observed. For example, the visual feature map 125 may store points, lines, curves, and other features identified by the SLAM engine from the real world objects 103A.

The reconstruction engine 121 uses the visual feature map 125 generated by the SLAM engine 116 to create a surfaced model of the scene 103 by interpolating surfaces from the said visual features. That is, the reconstruction engine 121 accesses the raw feature data from the visual feature map 125 (e.g., a set of lines and points from a plurality of frames) and constructs a three-dimensional representation to create surfaces from the visual features (e.g., planes).

The scene modeling function performed by the reconstruction engine 121 creates a 3D geometric model of the scene. It takes as input the feature map 125 generated by the SLAM engine 116 and creates a geometric surface model of the scene to generate a surface from points that are determined to be part of this surface. For example in creating an implicit surface using the visual feature points as key points, or by creating a mesh out of triangles created between points that are close to each other. By controlling how many visual features are collected by the SLAM engine 116 at each frame, and in turn controlling the density of the visual map 125, it is possible to create a surfaced virtual model that is close to the actual geometry of the real world being observed. The reconstruction engine 121 stores the 3D model in the virtual scene database 124.

The animation engine 123 is responsible for creating, changing, and animating virtual content. The animation engine 123 responds to animation state changes requested by the user interface manager 120 such as moving a virtual character from one point to another. The animation engine 123 in turn updates the position, orientation or geometry of the virtual content to be animated in each frame in the virtual database 124. The virtual content stored in the virtual scene database 124 is later rendered by the rendering engine 118 for presentation to the user.

The physics engine 122 interacts with the animation engine 123 to determine physics interactions of the virtual content with the three-dimensional model of the world. The physics engine 122 manages collisions between the geometry and content that it is provided with. For example, whether two geometries intersect, or whether a ray is intersecting with an object. It also provides a motion model between objects using programmable physical properties of those objects as well as gravity, so that the animation appears realistic. In particular, the physics engine 122 can provide collision and interaction information between the virtual objects from the animation engine 123 and the three-dimensional representation of the real world objects in addition to interactions between virtual content.

The virtual scene database 124 is a data structure storing both the 3D and 2D virtual content to integrate in the real world. This includes the 2D content such as text or a crosshair which is provided by the UI manager 120. It also includes 3D models in a spatial database of the real world 103A (or scene) created by the SLAM engine 116 and the reconstruction engine 121, as well as the 3D models of the virtual content to display as created by the animation engine 123. As such, the virtual scene database 124 provides the raw data to be rendered for presentation to the user's screen.

The rendering engine 118 receives the video feed from the camera 112 and adds the AR information and user interface information to the video frames for presentation to the user. The rendering engine 118's first function is to paint the video generated from the camera 112 into the screen 114. The second function is to use the pose of the device 102 (equivalent to hardware assembly 110 including the camera 112) with respect to the scene 103 and use that pose to generate the perspective view of the virtual scene database 124 from that said pose and then generate the corresponding 2D projected view 101 of this virtual content to display on the screen 114.

The rendering engine 118 renders 2D elements such as text and buttons which are fixed with respect to the screen 114 and their screen location is specified in term of screen coordinates. Those drawings are requested and controlled by the user interface manager 120 according to the state of the application. Depending on the implementation those 2D graphics are either generated every frame by application code or stored in the virtual database 124 after being created and further modified by the user interface manager 120, or a mix of both.

The rendering engine 118 “paints” the video frames captured by the camera 112 on the screen 114 so that the user is presented with a live view of the real world in front of the device, thereby creating the effect of seeing the real world through the device 102. That is, the rendering engine 118 displays the video frames captured by the camera 112 on the screen 102, which may be further modified by the rendering engine 118.

The rendering engine 118 also renders in 3D the virtual content 101 to add to the scene as seen from the viewpoint of the mobile device 102 (as determined by the pose). In this embodiment, the pose is provided by the user interface manager 120, though the pose could alternatively be provided directly by the pose manager 117. To correctly occlude rendering the virtual content 101 stored in the virtual scene database 124, the rendering engine 118 first renders from the same viewpoint the virtual model of the real scene generated by the scene modeling function. This virtual model of the real scene 103 is rendered transparently so it is invisible but the depth buffer is still being written with the depth of each pixel of this virtual model of the real world. This means when the virtual content 101 is added, it is correctly occluded depending on the relative depth at each pixel (i.e. at this specific pixel, is one model in front or behind the other) between the transparent virtual model of the scene overlaid on the real scene, and the virtual content. This produces the correct occlusion of the overlay 101 seen on the screen 114. The virtual model of the real scene 103 is rendered transparently, overlaid on the real scene 103. This means the video of the real scene 103 is clearly visible, creating the appearance of the real object 103 and the virtual content interacting.

The user interface (UI) manager 120 receives the pose of the device or hardware assembly 110 including camera 112 as reported by the pose manager 117, modifies or creates virtual content inside the virtual scene database 124, and controls the animation engine 123.

The overall application is controlled by the user interface manager 120, which stores the state of the application, and transitions to another state or produces application behaviors in response to user inputs, sensor inputs and other considerations. First the user interface manager 120 controls the rendering engine 118 depending on the state of the application. It might request 2D graphics to be displayed such as an introduction screen or some button or text to be displayed to show a high-score for example. The user manager also controls whether the rendering engine should show a 3D scene and if so uses the pose reported by the pose manager 117 and provides it as a viewpoint pose to the rendering engine 118. In addition the user manager controls the dynamic content by taking user input from buttons or finger touch events, or using the pose of the device 102 itself, as reported by the pose manager 117. To change the virtual content inside the database 124, the user interface manager 120 uses an animation engine 123 and sends it punctual requests of the desired end state of the virtual content, for example moving some virtual content from a real location A to a real location B. The engine 123 in turn keeps updating the virtual content every frame so that the requested end state is reached after a time specified by the user interface manager. The system 102 is further able to avoid the collision or intersection of virtual content with the real world, or more specifically the virtual model of the real world 103 created by the scene modeling process, by using a physics engine 122 which is able to determine if there is collision between two geometrical models. This allows for the animation engine 123 to control the animation at collision or to produce a motion path that prevents collision. By working with the interface manager 120, the animation engine can decide what to do with the virtual content when collision is detected, for example when the virtual content collides with the virtual model of the real scene, the animation engine 123 could switch to a new animation showing the virtual content bouncing back into the other direction.

### Dead Reckoning

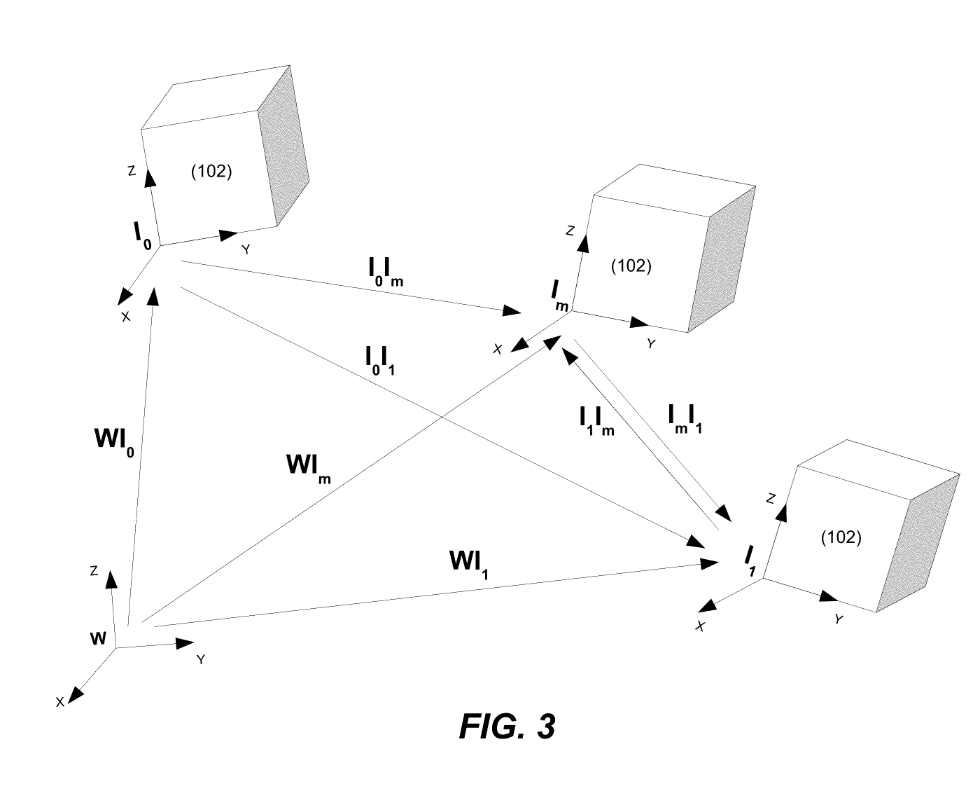

Referring now to FIG. 3, it illustrates the components of a dead reckoning calculation according to one embodiment. The dead reckoning calculations are performed by the dead reckoning module 115 using the sensor readings from the inertial motion unit 113 to provide a position to the pose manager 117.

In FIG. 3, the motion of the device 102 is shown between an initial time t₀ and a final time t₁. The referential pose of the IMU 113 attached to the object I is I₀ at initial time t₀ and is I₁ at final time t₁.

A typical dead reckoning computation is performed by double integrating the raw acceleration reported by the accelerometer to obtain a translation vector T₀₁. A single integration of the raw angular velocity reported by the gyroscopes obtain a rotation R₀₁. These indicate the translation and rotation made by the IMU 113 while taking the sensor readings. A pose change I₀I₁ is computed in the frame of reference of the IMU 113, I. However, the motion of the IMU is used in a static world frame of reference W and therefore the pose of the IMU is iteratively computed at each time frame with reference to the world frame reference using this formula:

WI₁=WI₀·I₀I₁=WI₀·R₀₁·T₀₁

That is, to obtain the new pose of the object 103 with respect to the world WI₁, the previous pose is added to the translation expressed in the IMU 113's frame of reference that is rotated according to the rotation performed during the frame of time considered. In this embodiment, to determine the translation and rotation components by integration, the initial values at time t₀ of translation speed as well as the pose of the IMU 113 known. The translation speed and pose may be determined by having an external sensor provide the speed at time t₀ or by making sure it is null by knowing that the IMU 113 is fixed at time t₀. Since dead-reckoning establishes a relative pose change, it is calculated from a known initial pose at the beginning of a dead-reckoning motion and from that point each initial pose for each time step is the pose from the previous time step.

This dead-reckoning approach produces a translation error E_{T} in the form:

E_{T}=a·t²+b·t^{3/2}

Where t is the elapsed time, a is the error due to the bias of the accelerometer and b is the error due to the white noise of the accelerometer. This approach also produces the rotation error E_{R} in the form:

E_{R}=c·t+d·t^{1/2}

Where c is the error due to the bias of the gyroscope and d is the error due to the white noise of the gyroscope.

In one embodiment, an alternative dead reckoning system provides a reduced error where the translation speed of the IMU 113 is known or null, at both time t₀ and time t₁. The translation speed can be determined with an external sensor to determine the speed or to consider the speed is nil based on other factors. For example, instructions can be provided to the user of the device to hold the device stationary. The external sensors may be any suitable device or method for determining translation speed, for example, a camera or other visual device or an electromagnetic device such as a laser. Several external sensors may be combined to determine a known translation speed for the IMU 113. The orientation change (i.e., the rotational orientation) is determined in one embodiment using dead-reckoning on the gyroscopic components of the IMU 113, specifically the rotation R₀₁ in the equation above.

Using the known translation speed at the initial and final time, the dead reckoning calculation is improved by calculating the dead reckoning twice. The motion time is divided in half, and a first calculation is made from the first time t₀ to the midpoint tₘ and another from t₁ to the midpoint tₘ. The dead reckoning integration above is performed twice to each half: one from time t₀ to time tₘ to compute the relative pose I₀Iₘ, and another one applied backward from time t₁ to time tₘ to obtain the relative pose I₁Iₘ. The second dead-reckoning is performed backwards from t₁ (rather than forward from tₘ) because the translation speed of the IMU 113 is known at time t₁ but not at time tₘ. By taking this approach, the new pose of the device is computed by:

WI₁=WI₀·I₀Iₘ·IₘI₁=WI₀·I₀Iₘ·I₁Iₘ⁻¹=WI₀·T₀ₘ·R₁₀·T₁ₘ

Specifically it applies these following steps: (1) integrate accelerometers from t₀ to tₘ, to obtain forward translation vector T₀ₘ (2) integrate accelerometers back from t₁ to tₘ to obtain backward displacement vector T₁ₘ (3) integrate gyroscopes we obtain the rotation measurement R₀₁ from t₀ to t₁ (4) rotate T₁ₘ in the frame of reference of I₀ using R₀₁ and (5) add forward and backward displacement vectors.

As a consequence, the error produced by the translation and orientation computation using this method is:

E_{T}=a·(t/2)²+b·(t/2)^{3/2}=a·t/4+b·t^{3/2}/2^{3/2}E_{R}=c·t+d·t^{1/2}

Therefore this method reduce the translation error by 4 for the bias and by 2^{2/3} for the white noise components. Since this method only requires the user maintain the device at a particular location, the user interface can instruct the user to not move the device 102 at particular points in time. As such, this dead reckoning method can be used to significantly reduce the dead reckoning error. In addition, the system can use this method to delay the period of time until the system reaches a threshold level of error. By reducing the rate of growth of the sensor drift, this technique allows more reliable use of sensors above the level previously possible for the sensor's sampling rate and calibration.

### Computing Machine Architecture

FIG. 4 is a block diagram illustrating components of an example machine able to read instructions from a machine-readable medium and execute them in a processor (or controller). Specifically, FIG. 4 shows a diagrammatic representation of a machine in the example form of a computer system 200 within which instructions 224 (e.g., software) for causing the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment. Note that here, the mobile device 102 may be embodied as a machine or computer system 200.

The machine may be a server computer, a client computer, a personal computer (PC), a tablet PC, a set-top box (STB), a personal digital assistant (PDA), a cellular telephone, a smartphone, a web appliance, or any machine capable of executing instructions 224 (sequential or otherwise) that specify actions to be taken by that machine. Further, while only a single machine is illustrated, the term “machine” shall also be taken to include any collection of machines that individually or jointly execute instructions 224 to perform any one or more of the methodologies discussed herein.

The example computer system 200 includes a processor 202 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 204, a static memory 206, and a camera (not shown), which are configured to communicate with each other via a bus 208. The computer system 200 may further include graphics display unit 210 (e.g., a plasma display panel (PDP), a liquid crystal display (LCD), a projector, or a cathode ray tube (CRT)). The computer system 200 may also include alphanumeric input device 212 (e.g., a keyboard), a cursor control device 214 (e.g., a mouse, a trackball, a joystick, a motion sensor, or other pointing instrument), a storage unit 216, a signal generation device 218 (e.g., a speaker), and a network interface device 220, which also are configured to communicate via the bus 208.

The storage unit 216 includes a machine-readable medium 222 on which is stored instructions 224 (e.g., software) embodying any one or more of the methodologies or functions described herein. The instructions 224 (e.g., software) may also reside, completely or at least partially, within the main memory 204 or within the processor 202 (e.g., within a processor's cache memory) during execution thereof by the computer system 200, the main memory 204 and the processor 202 also constituting machine-readable media. The instructions 224 (e.g., software) may be transmitted or received over a network 226 via the network interface device 220.

While machine-readable medium 222 is shown in an example embodiment to be a single medium, the term “machine-readable medium” should be taken to include a single medium or multiple media (e.g., a centralized or distributed database, or associated caches and servers) able to store instructions (e.g., instructions 224). The term “machine-readable medium” shall also be taken to include any medium that is capable of storing instructions (e.g., instructions 224) for execution by the machine and that cause the machine to perform any one or more of the methodologies disclosed herein. The term “machine-readable medium” includes, but not be limited to, data repositories in the form of solid-state memories, optical media, and magnetic media.

### Additional Configuration Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms, for example, as illustrated in FIG. 2. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors, e.g., processor 202, that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for capturing information about real world objects, building a three-dimensional model of the real world objects, and rendering objects capable of occlusion and collusion with the three-dimensional model for rendering on a live video through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A method for determining the position of a dead reckoning system comprising:
determining an initial position of the dead reckoning system within a frame of reference;
receiving data indicative of rotation and acceleration of the dead reckoning system from an initial time to a final time, the initial time associated with the initial position and the final time is associated with a final position;
selecting an intermediate time between the first time and the second time;
calculating a first translation segment from the first time to the intermediate time using the received data indicative of rotation and acceleration;
calculating a second translation segment from the second time to the intermediate time using the received data indicative of rotation and acceleration; and
determining the final position of the dead reckoning system using the initial position, the first translation segment, and the second translation segment.

2. The method of claim 1, wherein the initial position is associated with an initial known translation speed.

3. The method of claim 2, wherein the initial known translation speed is zero.

4. The method of claim 1, wherein the final position is associated with a final known translation speed.

5. The method of claim 4, wherein the final known translation speed is zero.

6. The method of claim 4, wherein the final known translation speed is determined by an external sensor.

7. The method of claim 1, wherein the intermediate time is half of the time between the initial time and the final time.

8. A system for augmenting real-world objects with virtual content, comprising:
a processor configured to execute instructions;
a memory including instructions when executed by the processor cause the processor to:
receive data indicative of rotation and acceleration of the dead reckoning system from an initial time to a final time, the initial time associated with the initial position and the final time is associated with a final position;
select an intermediate time between the first time and the second time;
calculate a first translation segment from the first time to the intermediate time using the received data indicative of rotation and acceleration;
calculate a second translation segment from the second time to the intermediate time using the received data indicative of rotation and acceleration; and
determine the final position of the dead reckoning system using the initial position, the first translation segment, and the second translation segment.

9. The method of claim 8, wherein the initial position is associated with an initial known translation speed.

10. The method of claim 9, wherein the initial known translation speed is zero.

11. The method of claim 8, wherein the final position is associated with a final known translation speed.

12. The method of claim 11, wherein the final known translation speed is zero.

13. The method of claim 11, wherein the final known translation speed is determined by an external sensor.

14. The method of claim 8, wherein the intermediate time is half of the time between the initial time and the final time.

15. A computer-readable medium for augmenting real-world objects with virtual content, comprising instructions causing a processor to:
receive data indicative of rotation and acceleration of the dead reckoning system from an initial time to a final time, the initial time associated with the initial position and the final time is associated with a final position;
select an intermediate time between the first time and the second time;
calculate a first translation segment from the first time to the intermediate time using the received data indicative of rotation and acceleration;
calculate a second translation segment from the second time to the intermediate time using the received data indicative of rotation and acceleration; and
determine the final position of the dead reckoning system using the initial position, the first translation segment, and the second translation segment.

16. The method of claim 15, wherein the initial position is associated with an initial known translation speed.

17. The method of claim 16, wherein the initial known translation speed is zero.

18. The method of claim 15, wherein the final position is associated with a final known translation speed.

19. The method of claim 18, wherein the final known translation speed is zero.

20. The method of claim 18, wherein the final known translation speed is determined by an external sensor.
